(19) United States
(12) Patent Application Publication
(10) Pub. No.: US 2010/0272932 A1
(43) Pub. Date: Oct. 28, 2010

(54) DECORATIVE COMPONENT

(75) Inventors: Masao Izumo, Tokyo (JP); Masaru Imaizumi, Tokyo (JP); Mizuki Ogawa, Tokyo (JP); Hiroshi Onishi, Tokyo (JP)

Correspondence Address: BUCHANAN, INGERSOLL & ROONEY PC, POST OFFICE BOX 1404, ALEXANDRIA, VA, 22313-1404, US

(73) Assignee: Mitsubishi Electric Corporation, Chiyoda-ku (JP)

(21) Appl. No.: 12/747,301

(22) PCT Filed: Mar. 7, 2008
(86) PCT No.: PCT/JP2008/054154

§ 371 Date: Jun. 10, 2010

(51) Int. Cl. B32B 1/02; B32B 5/00; B32B 3/26

(52) U.S. Cl. 428/34.1; 428/336; 428/319.1

(57) ABSTRACT

In a conventional decorative component, a conductive material is formed on the entire surface of an insulation part so that the decoration part looks in metallic color. However, an electric current flows through the inside of the conductive material, and hence electromagnetic waves applied to the decoration part suffers a loss. This poses a problem that sufficient antenna characteristics cannot be obtained. On the member surface, a semiconductor layer or a semi-metal layer with a film thickness of 5 nm or more, and a mean transmittance of 65% or less and a mean reflectance of 20% or more at 400 nm to 800 nm is formed. This can implement a decorative component exhibiting a sufficient metallic luster without blocking the electromagnetic waves.

### TECHNICAL FIELD

This invention relates to a decorative component for use in a housing of an electronic device for transmitting and receiving electromagnetic waves, or the like.

### BACKGROUND ART

In this conventional type of decorative component, a metallic luster is obtained by depositing particles of a conductive material in a non-contact manner therebetween on an insulation material (e.g., Patent Document 1).

Patent Document 1: JP-A-2003-298326

### DISCLOSURE OF THE INVENTION

### Problem that the Invention is to Solve

In a device for transmitting and receiving electromagnetic waves, application of metal components has been limited in order to sufficiently ensure the performances of an antenna without intercepting electromagnetic waves. On the other hand, there has been a demand for a decorative component exhibiting a metallic luster in order to enhance the design quality of the device. In Patent Document 1, particles of a conductive material are discontinuously deposited in a non-contact manner therebetween on an insulation material, thereby to obtain a metallic luster at the decoration part. However, in a conventional decorative component, a conductive material is formed on the entire surface of the insulation part so that the decoration part looks in metallic color. However, an electric current flows through the inside of the conductive material, and hence electromagnetic waves applied to the decoration part suffer a loss. This entails a problem that sufficient antenna characteristics cannot be obtained.

In order to solve the foregoing problem, it is an object of this invention to provide a decorative component exhibiting a metallic luster without intercepting electromagnetic waves.

### Means for Solving the Problem

A decorative component in accordance with this invention is configured such that, a semiconductor layer or a semi-metal layer with a film thickness of 5 nm or more, and a mean transmittance of 65% or less and a mean reflectance of 20% or more at a film thickness of 400 nm to 800 nm is formed on the surface of a member.

### Advantage of the Invention

In accordance with a decorative component of this invention, as compared with the case where a conductive material is used as in the related art, transmission of electromagnetic waves is not blocked, and as a housing of an electronic device such as a cellular phone, a metallic luster is ensured, and further, prescribed antenna characteristics can be ensured with ease. In addition, as compared with conventional discontinuous deposition, there is almost no restriction on the film thickness of the semiconductor film or the semi-metal film in practical use. Accordingly, manufacturing thereof is easy, which reduces the manufacturing cost.

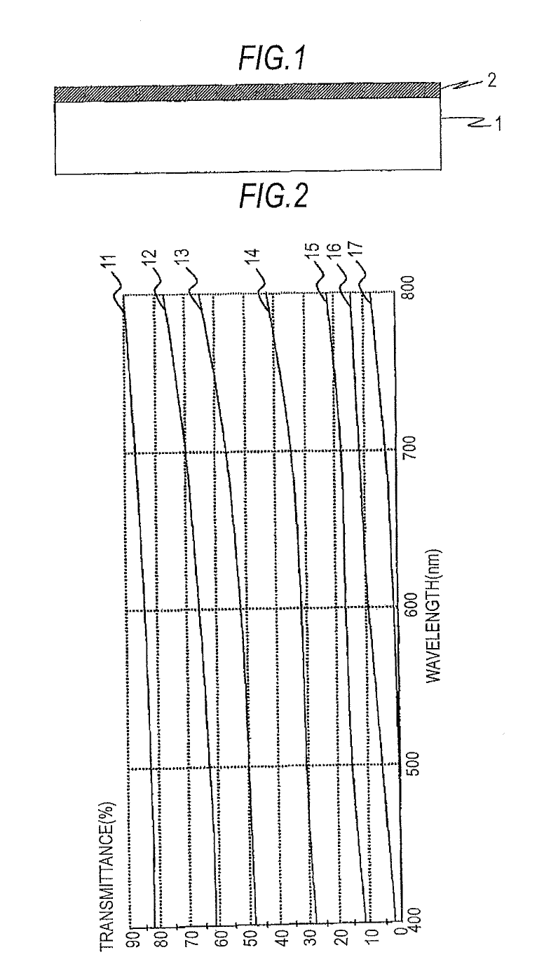

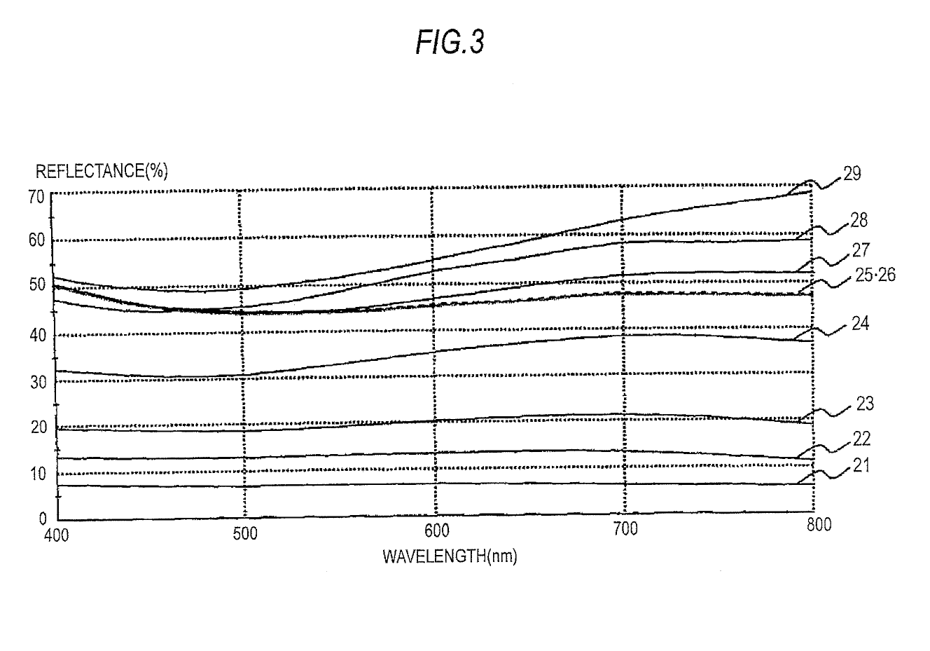

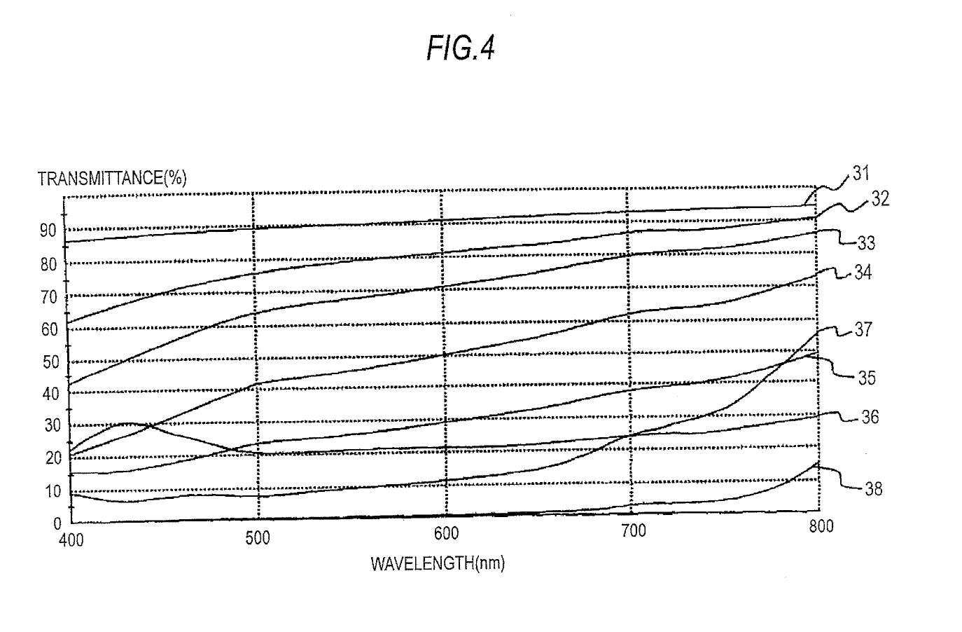

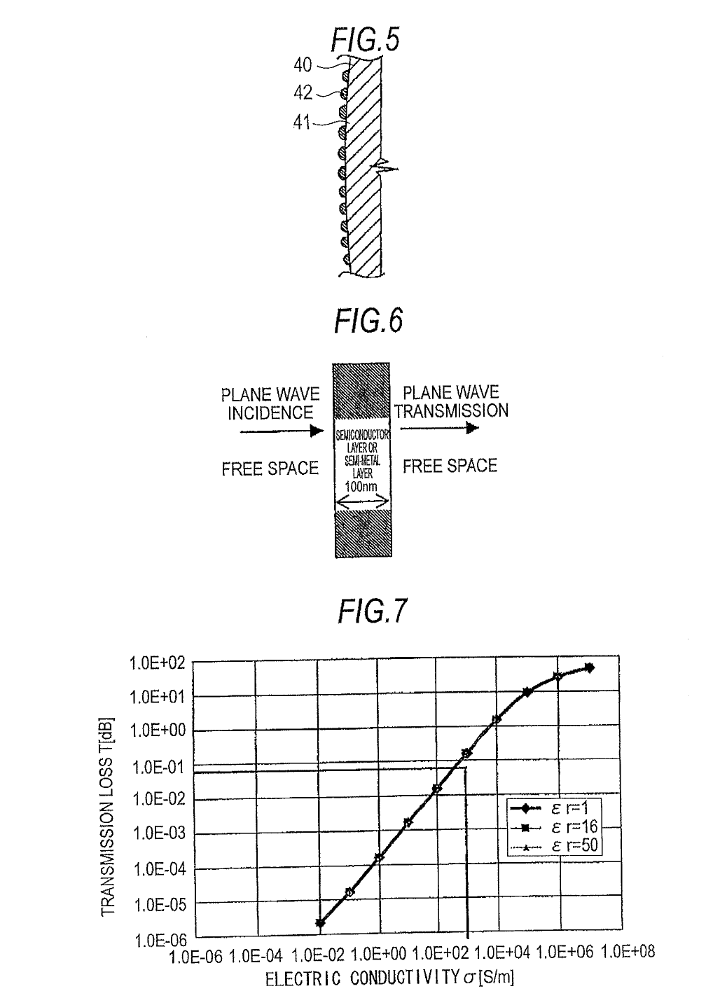

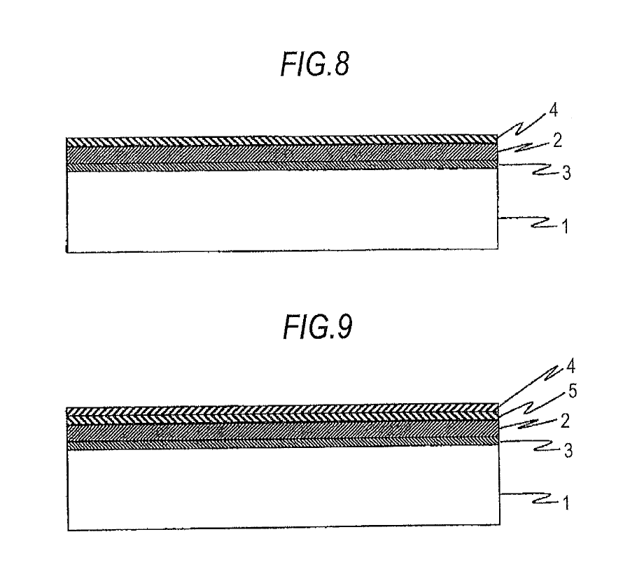

### BRIEF DESCRIPTION OF THE DRAWINGS

[FIG. 1] A cross-sectional view showing a decorative component in accordance with Embodiment 1 of this invention;

[FIG. 2] A view illustrating the transmittance characteristic of Ge;

[FIG. 3] A view illustrating the reflectance characteristic of Ge;

[FIG. 4] A view illustrating the reflectance characteristic of Si;

[FIG. 5] A cross-sectional view illustrating a conventional decorative component;

[FIG. 6] A view illustrating a calculation model for studying the transmission loss of electromagnetic waves;

[FIG. 7] A view illustrating the results obtained by calculating the transmission loss of electromagnetic waves;

[FIG. 8] A cross-sectional view showing a decorative component in accordance with Embodiment 2 of this invention; and

[FIG. 9] A cross-sectional view showing a decorative component in accordance with Embodiment 3 of this invention.

### DESCRIPTION OF REFERENCE NUMERALS AND SIGNS

1 Base material; 2 Semiconductor layer or semi-metal layer; 3 Undercoat layer; 4 Protective layer; 5 Intermediate layer; 40 Decoration part; 41 Insulation part; 42 Conductive material

### BEST MODE FOR CARRYING OUT THE INVENTION

### Embodiment 1

FIG. 1 is a cross-sectional view showing a decorative component in accordance with Embodiment 1 of this invention, which is a component forming the design of a cellular phone housing. On the surface of a base material 1, a semiconductor layer or a semi-metal layer 2 is formed.

The material forming the base material 1 is an insulator including, for example, a resin such as a polycarbonate resin (PC resin), an acrylonitrile butadiene styrene resin (ABS resin), a polymer alloy of a PC resin and an ABS resin (PC+ABS resin), a methyl polymethacrylate (PMMA resin), or a polyamide resin (PA resin) , or a resin including a filler added therein such as a glass fiber.

Whereas, as the semiconductor layer or semi-metal layer 2, mention may be made of germanium Ge, silicon Si, alpha tin α-Sn, selenium Se, or tellurium Te as a typical example. The material has no particular restriction so long as it exhibits a metallic luster. However, it is more preferable that the electric conductivity of the semiconductor or the semi-metal is 10³ S/m or less as the range not to affect the electromagnetic waves.

Herein, the semi-metal denotes an element showing a metallic conductivity, but having a larger electric resistance than those of common metals. In the long-form periodic table, an oblique line connecting boron B and astatine At is a border line between metals and non-metals. The semi-metals mean those obtained by excluding semiconductors (Ge, Si, α-Sn, Se, and Te) from the elements in the vicinity of the border line, i.e., boron B, carbon C, silicon Si, phosphorus P, germanium Ge, arsenic As, selenium Se, tin Sn, tellurium Te, bismuth Bi, polonium Po, and astatine At).

The semiconductor layer or the semi-metal layer 2 can be formed with, for example, vacuum deposition. One example of the formation method will be mentioned. The base material 1 is set at a prescribed position of a vacuum deposition device, and as a deposition material, particulate Ge is set on a filament formed of tungsten. The vacuum deposition device is vacuum evacuated to reach a prescribed degree of vacuum. In this state, the tungsten filament is energized, so that Ge is evaporated at a time, and is deposited on the base material 1, to form the semiconductor layer or the semi-metal layer 2. Such a thin film formation method is a method referred to as a so-called flash deposition. This method is capable of inhibiting the thermal effect on the base material, and is suitable for formation of a thin film on a resin base material. Other than this, with vacuum deposition, there is also a process in which a material is molten with an electronic beam. However, in general, the radiant heat of the evaporation material is large. For this reason, when a base material which dislikes a thermal effect is used, a large vacuum tank becomes necessary.

Further, for the flash deposition, when the surface of the base material 1 is irradiated with argon (Ar) ions, oxygen (O₂) ions, or the like, using an ion gun or an antenna type bombardment device, the film adhesion of the semiconductor layer or the semi-metal layer 2 is improved, which is preferable. Herein, the antenna type bombardment device denotes a device in which a circular coil is provided in a deposition chamber, and with this as an electrode, a plasma is generated throughout the chamber.

FIG. 2 is a view showing the transmittance characteristic of Ge when the base material is glass, wherein the abscissa denotes the wavelength (nm), and the ordinate denotes the transmittance (T %) . Characteristic curves 11 to 17 show the transmittance characteristics with respect to Ge film thicknesses of 1 nm, 3 nm, 5 nm, 10 nm, 20 nm, 40 nm, and 100 nm, respectively.

As indicated from FIG. 2, it is indicated that Ge decreases in transmittance with an increase in film thickness. When the film thickness is larger than 5 nm, the mean transmittance in a visible light region at a wavelength of 400 nm to 800 nm is 65% or less. According to the investigation by the inventors, a weak metallic luster begins to be exhibited from at a Ge film thickness of about 5 nm, and a clear metallic luster begins to be exhibited at 100 nm. Accordingly, decoration exhibiting a metallic luster is implemented when the mean transmittance in a visible region at 400 nm to 800 nm is 65% or less, and preferably about 5% or less.

FIG. 3 is a view showing the reflectance characteristic of Ge when the base material is glass, wherein the abscissa denotes the wavelength (nm), and the ordinate denotes the transmittance (T %). Characteristic curves 21 to 29 show the reflectance characteristics with respect to Ge film thicknesses of 1 nm, 3 nm, 5 nm, 10 nm, 1000 nm, 400 nm, 100 nm, 20 nm, and 40 nm, respectively. The respective characteristic curves 25 and 26 with respect to 1000 nm and 400 nm almost overlap each other.

As described above, according to the investigation by the inventors, a weak metallic luster begins to be exhibited from at a Ge film thickness of about 5 nm, and a clear metallic luster begins to be exhibited at 100 nm. Accordingly, decoration exhibiting a metallic luster is implemented when the mean reflectance in a visible region at 400 nm to 800 nm is 20% or more, and preferably about 40% or more.

FIG. 4 is a view showing the transmittance characteristic of Si when the base material is glass, wherein the abscissa denotes the wavelength (nm), and the ordinate denotes the transmittance (T %). Characteristic curves 31 to 38 show the transmittance characteristics with respect to Si film thicknesses of 1 nm, 3 nm, 5 nm, 10 nm, 20 nm, 40 nm, 100 nm, and 400 nm, respectively.

As indicated from FIG. 4, as different from Ge, Si causes an effect of interference at a film thickness of 40 nm or more, and increases in transmittance with an increase in film thickness according to the wavelength band. This means as follows: from the viewpoint of decoration, there is a feature that the color control is unstable, but color is changeable according to the viewing angle.

When decoration is carried out with the semiconductor layer or the semi-metal layer 2, the following merit is produced. Namely, conventionally, decoration of a component has been carried out by forming a metal material such as aluminum Al or tin Sn on the component surface. The reason for this is as follows. In the case of a metal film, as described in connection with Ge above, the metal film has a characteristic of decreasing in transmittance with an increase in film thickness, and exhibiting a metallic luster; this facilitates the film thickness control for decoration.

However, when the decorative component is used as a housing of a cellular phone, the following problem occurs. Namely, for a recent cellular phone housing, importance is attached on the design quality. For this reason, an antenna for transmitting and receiving radio waves between the cellular phone and the base station is often disposed inside the housing. Thus, use of a decorative component including a metal film formed therein is limited, resulting in a restriction in terms of the design of the housing appearance. In recent years, in order to solve this problem, as described above, there has been developed and has come into practical use a so-called discontinuous deposition technology of forming the metal films in islands.

FIG. 5 is a cross-sectional view showing a decoration part in a conventional antenna device, wherein 40 represents a decoration part; 41, an insulation part; and 42, a particle of a conductive material. In the decoration part 40 in the conventional antenna device, the conductive material 42 is in the form of particles, which are formed in a non-contact manner therebetween. Accordingly, radio waves are partially transmitted through the conductive material 42 and the insulation part 41.

However, the conductive material 42 is formed on the entire surface of the insulation part 41 so that the decoration part 40 looks in metallic color, and an electric current flows through the inside of the conductive material 42. This causes a loss in electromagnetic waves applied to the decoration part 40, which entails a problem that sufficient antenna characteristics cannot be obtained. Whereas, generally, it is in a film as very thin as to about several tens angstroms that the deposition material becomes discontinuous. In general, with such a film thickness as to exceed 100 angstroms, these islands come in contact with each other, resulting in impairment of the antenna characteristics.

Therefore, in general, the foregoing discontinuous deposition involves a restriction on the thickness. When the film thickness has a restriction, it is difficult to form a film uniformly on the entire surface of a rectangular member or a member having a curved surface such as a housing of a cellular phone, which leads to a reduction of the yield. Other than this, there is also conceivable a method in which, using laser or an exposure technology, a pattern is formed on a metal film to implement discontinuity. This however incurs an increase in cost, which restricts the range of application.

The decorative component in accordance with this invention was developed for the purpose of solving such a problem. Namely, a semiconductor film or a semi-metal film is used in place of a conventional conductive material. For this reason, the decorative part does not block transmission of electromagnetic waves, and can ensure a metallic luster, and further can ensure prescribed antenna characteristics with ease as the housing of a cellular phone. Further, as compared with conventional discontinuous deposition, there is almost no restriction in practical use on the film thickness of the semiconductor film or the semi-metal film. This provides an advantage in that manufacturing thereof is easy, resulting in reduction of the manufacturing cost.

The relationship in transmission and interception between the metal film or the semiconductor film and electromagnetic waves can be generally understood as follows. Namely, the electromagnetic waves for use in a cellular phone are called centimeter waves or microwaves, and ranges about 1 mm to 1 min terms of wavelength region. In the case of the metal film, upon irradiation with the electromagnetic waves, free electrons form a barrier (polarizing action), which prevents penetration into the film. This results in that electromagnetic waves are reflected by the metal film. On the other hand, in the case of the semiconductor film, the film does not have free electrons like those of the metal film, so that the polarizing action occurring in the metal film does not occur. In a semiconductor, for example, Si has a band gap of about 1.1 eV (corresponding to the energy which an electromagnetic wave with a wavelength of 1127 nm has), and Ge has a band gap of about 0.7 eV (corresponding to the energy which an electromagnetic wave with a wavelength of 1850 nm has) . Thus, electromagnetic waves with longer wavelengths than the wavelength corresponding to the band gap are not absorbed. This allows electromagnetic waves for use in a cellular phone to be transmitted through the housing even when the semiconductor is formed on the surface.

FIG. 7 shows the results of the study on the electric conductivity required of a semiconductor or a semi-metal necessary for allowing sufficient transmission of electromagnetic waves therethrough. Based on the one-dimensional calculation model shown in FIG. 6, the transmission loss T (dB) when a plane wave from the left is made incident perpendicularly upon the semiconductor layer or the semi-metal layer (dielectric constant εr, electric conductivity σ) was calculated, provided that the thickness of the semiconductor layer or the semi-metal layer was assumed to be 100 nm. Incidentally, the dielectric constant εr was determined for 1, 16, 50, which hardly affects the transmission loss T (dB). This indicates that the electric conductivity required of a semiconductor or a semi-metal is 10³ S/m or less when the threshold value of the transmission loss T (dB) allowing sufficient transmission of electromagnetic waves, and satisfying the function as a cellular phone is assumed to be −0.1 dB or less. The electric conductivities of Ge and Si described in this embodiment are 2.1 S/m (at 300 K) and 3.16×10⁻⁴ S/m (at 300 K), respectively, both of which are far lower than 10³ S/m.

Incidentally, in the foregoing embodiment, some examples of resins were mentioned as the materials forming the base material 1. However, the base material 1 is not limited to the resins mentioned above. It is naturally understood that even other thermoplastic resins or thermosetting resins, and further, other insulators such as glass and ceramics do not pose any particular problem, and produce the same effects.

Further, as the deposition method of the semiconductor layer or the semi-metal layer 2, the method using a vacuum deposition process was described. However, the manufacturing method of the semiconductor layer or the semi-metal layer 2 is not limited thereto. Any method is acceptable so long as it does not cause thermal damage to the component surface. It is naturally understood that there can be used physical methods such as a sputtering method, an ion plating method, and a spin coating method, or chemical methods such as a CVD method and a plating method.

Further, in the embodiment, a description was given to the case where the semiconductor layer or the semi-metal layer 2 is a monolayer. However, the semiconductor layer or the semi-metal layer may be a multilayer so long as it is in such a range as not to block electromagnetic waves. For example, mention may be made of the case of a multilayer structure of Si and Ge, and the case of simultaneous deposition of Si and Ge.

Further, in the embodiment, the application example to the housing of the cellular phone was shown. However, the application of the decorative component in accordance with this invention is not limited to such an example. It is naturally understood that the decorative component is applicable to electronic devices for transmitting and receiving various electromagnetic waves, such as camera, portable music playback machine, portable game machine, portable communication device, radio, television set, notebook personal computer, notebook word processor, video camera, electronic notepad, various infrared ray system or radio system remote controllers, electronic calculator, and automotive electronic control device.

Semiconductors typified by Ge and Si have a characteristic of transmitting not only electromagnetic waves but also near infrared to far infrared rays therethrough. For this reason, it is naturally understood that the semiconductor also produces the same effects as the housing of a device using, for example, an infrared ray sensor.

As described up to this point, the decorative component in accordance with this invention includes a semiconductor layer or a semi-metal layer with a film thickness of 5 nm or more, and with a mean transmittance of 65% or less and a mean reflectance of 20% or more in the visible light region at a wavelength of 400 nm to 800 nm, formed on the surface of the member. Accordingly, as compared with the case where a conductive material is used as in the related art, transmission of electromagnetic waves is not blocked, and as a housing of an electronic device such as a cellular phone, the metallic luster is ensured, and further, prescribed antenna characteristics can be ensured with ease. In addition, as compared with conventional discontinuous deposition, there is almost no restriction on the film thickness of the semiconductor film or the semi-metal film in practical use. This provides an advantage in that manufacturing thereof is easy, resulting in reduction of the manufacturing cost.

### Embodiment 2

FIG. 8 is a cross-sectional view showing a decorative component in accordance with Embodiment 2 of this invention, wherein on the surface of a base material 1, an undercoat layer 3 is provided, and a semiconductor layer or a semi-metal layer 2 is provided thereon. On the semiconductor layer or the semi-metal layer 2, a protective layer 4 is further provided to protect the semiconductor layer or the semi-metal layer 2. Provision of the undercoat layer 3 is in order to improve the adhesion between the base material 1 and the semiconductor layer or the semi-metal layer 2. Other configurations are the same as the case shown in Embodiment 1.

The undercoat layer 3 produces a large effect particularly when the base material 1 is a resin. It is generally referred to as an undercoat, and various resin materials can be used therefor. The protective layer 4 is also referred to as an overcoat or a hard coat, and a permeable material having a relatively high hardness is used therefor.

By adopting the configuration in accordance with this invention, in addition to the effects shown in Embodiment 1, a decorative component improved in adhesion of the semiconductor layer or the semi-metal layer 2 is implemented.

### Embodiment 3

FIG. 9 is a cross-sectional view showing a decorative component in accordance with Embodiment 3. In addition to the configuration shown in Embodiment 2, an intermediate layer 5 is provided between the semiconductor layer or the semi-metal layer 2 and the protective layer 4. Other configurations are the same as the case shown in Embodiment 1. The intermediate layer 5 is also referred to as a middle coat, and aims to improve the adhesion between the semiconductor layer or the semi-metal layer 2 and the protective layer 4, and to change the outward appearance by addition of a pigment therein. For the intermediate layer 5, various permeable resins can be used.

By adopting the configuration in accordance with this invention, in addition to the effects shown in Embodiment 2, a decorative component improved in adhesion of the protective layer 4, and excellent in design quality is implemented.

1. A decorative component comprising a semiconductor layer or a semi-metal layer with a film thickness of 5 nm or more, selected from a group of germanium Ge, alpha-tin α-Sn, selenium Se, and tellurium Te formed on the surface of a member.

2. The decorative component according to claim 1, wherein the semiconductor layer or the semi-metal layer has a mean transmittance of 65% or less, and a mean reflectance of 20% or more at a wavelength of 400 nm to 800 nm.

3. The decorative component according to claim 2, wherein the semiconductor layer or the semi-metal layer has a mean transmittance of 5% or less, and a mean reflectance of 40% or more.

4. The decorative component according to claim 1, wherein the semiconductor layer or the semi-metal layer has an electric conductivity of 10³ S/m or less.

5. The decorative component according to claim 1, wherein a protective layer comprising a permeable material having a high hardness is provided on the semiconductor layer or the semi-metal layer.

6. The decorative component according to claim 5, wherein an intermediate layer comprising a permeable resin is provided between the semiconductor layer or the semi-metal layer and the protective layer.

7. A housing of an electronic device, comprising the decorative component according to claim 1.
